(19) United States
(12) Patent Application Publication
(10) Pub. No.: US 2014/0104208 A1
(43) Pub. Date: Apr. 17, 2014

(54) TOUCH INTEGRATED CIRCUIT, TOUCH SENSING DEVICE INCLUDING THE SAME AND DRIVING METHOD THEREOF

(71) Applicant: SAMSUNG ELECTRONICS CO., LTD., Suwon-Si (KR)

(72) Inventors: JongOh LEE, Anyang-Si (KR); SangJoon HYUNG, Seoul (KR); SeokHee HWANG, Seoul (KR)

(73) Assignee: SAMSUNG ELECTRONICS CO., LTD., Suwon-Si (KR)

(21) Appl. No.: 14/050,867

(22) Filed: Oct. 10, 2013

(30) Foreign Application Priority Data
Oct. 11, 2012 (KR) 10-2012-0112955

(51) Int. Cl. G06F 3/041

(52) U.S. Cl. CPC G06F 3/0416
USPC 345/173

(57) ABSTRACT

A touch sensing device includes a touch panel, a touch integrated circuit configured to scan the touch panel at a scan frequency, and an application processor configured to provide application information on an application activated at the touch sensing device. The touch integrated circuit is configured to adjust the scan frequency in response to the application information.

### CROSS-REFERENCE TO RELATED APPLICATIONS

A claim for priority under 35 U.S.C. §119 is made to Korean Patent Application No. 10-2012-0112955 filed Oct. 11, 2012, in the Korean Intellectual Property Office, the entire contents of which are hereby incorporated by reference.

### BACKGROUND

The inventive concepts described herein relate to a touch integrated circuit and a driving method of a touch sensing device including the same.

In recent years, mobile communications devices and computing devices may have adopted a touch sensing device such as a touch screen as an input means. The touch sensing device may recognize a touch of a user using a variation in an electrical signal generated when the user touches the touch panel. A computing processor connected with the touch sensing device may analyze a touch of the user according to a given user interface at generation of a touch event, and may perform various operations according to the analyzing result.

The touch sensing device may use a variety of manners such as a resistive overlay manner, a capacitive overlay manner, a surface acoustic wave manner, an infrared manner, an inductive manner, and so on.

### SUMMARY

At least one example embodiment of inventive concepts is directed to provide a touch sensing device including a touch panel, a touch integrated circuit configured to scan the touch panel at a scan frequency, and an application processor configured to provide application information on an application activated at the touch sensing device, wherein the touch integrated circuit is configured to adjust the scan frequency in response to the application information.

In at least one example embodiment, the touch panel includes a plurality of TX driving lines, a plurality of RX sensing lines, and a sensing node array including sensing nodes formed at intersections of the TX driving lines and the RX sensing lines, wherein the touch integrated circuit is configured to provide a driving current having the scan frequency to the TX driving lines.

In at least one example embodiment, applications are divided into a plurality of groups according to touch recognition speeds. The application information identifies a group of plurality of groups to which the activated application belongs, the touch integrated circuit has a register storing a plurality of scan frequencies corresponding to the plurality of groups, and the touch integrated circuit loads one of the plurality of scan frequencies in response to the application information to drive the touch panel with the loaded scan frequency.

At least one example embodiment of inventive concepts is directed to provide a touch integrated circuit configured to scan a touch panel at a scan frequency. The touch integrated circuit configured to adjust the scan frequency in response to application information provided from an application processor, the application information is information associated with an activated application.

In at least one example embodiment, the application information is a scan frequency control signal indicating a touch recognition speed of the activated application requires.

In at least one example embodiment, the touch integrated circuit includes a touch driver configured to provide the touch panel with a driving current having the scan frequency; a signal processing unit configured to convert an electrical signal provided from the touch panel into a digital signal; and a control unit configured to determine a touch state of the touch panel based on the digital signal.

In at least one example embodiment, the application information identifies a group of a plurality of groups to which the activated application belongs.

In at least one example embodiment, the touch integrated circuit further includes a register configured to store a plurality of scan frequencies corresponding to the plurality of groups, wherein the touch integrated circuit is configured to load one of the plurality of scan frequencies in response to the application information to drive the touch panel with the loaded scan frequency.

In at least one example embodiment, the register further stores a default scan frequency and the touch integrated circuit is configured to drive the touch panel with the default scan frequency at booting.

Still another example embodiment of inventive concepts is directed to provide a method of operating a touch sensing device which scans a touch panel at a scan frequency, the operating method including recognizing a type of application activated on the touch sensing device, deciding the scan frequency based on the recognized application type, and driving the touch panel with the decided scan frequency.

In at least one example embodiment, the deciding the scan frequency based on the recognized application type includes selecting one frequency from among a plurality of frequencies, the selected frequency corresponding to the recognized application type.

In at least one example embodiment, the type of application is recognized according to a touch sensing speed associated with the application.

In example embodiments, the operating method further includes driving the touch panel with a default scan frequency during booting of the touch sensing device.

In at least one example embodiment, the operating method further includes terminating the activated application, and driving the touch panel with the default scan frequency after the terminating.

In at least one example embodiment, the operating method further includes switching the activated application, and again deciding the scan frequency based on a type of the switched application.

At least one example embodiment discloses a touch panel integrated circuit configured to adjust a scan frequency of the touch panel based on an application.

In at least one example embodiment, the touch panel integrated circuit includes a register configured to store a plurality of candidate scan frequencies and the touch panel is configured to select one of the plurality of candidate scan frequencies as the adjusted scan frequency.

In at least one example embodiment, the touch panel integrated circuit is configured to select one of the plurality of candidate scan frequencies based on a type of the application.

In at least one example embodiment, the touch panel integrated circuit is configured to adjust the scan frequency based on a type of the application.

With example embodiments of inventive concepts, power consumption may be reduced by changing a scan frequency according to an activated application.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a touch sensing device according to an example embodiment of inventive concepts;

FIG. 2 is a detailed block diagram illustrating a touch panel 110 and a touch integrated circuit of FIG. 1;

FIG. 3 is a block diagram schematically illustrating layers of an application processor of FIG. 1;

FIG. 4 is a block diagram schematically illustrating a touch sensing device according to another example embodiment of inventive concepts;

FIG. 5 is a flow chart illustrating a driving method of a touch sensing device according to an example embodiment of inventive concepts;

FIG. 6 is a flow chart illustrating a method of controlling an operation of a touch sensing device according to an example embodiment of inventive concepts;

FIG. 7 is a diagram illustrating a handheld phone to which a touch sensing device of inventive concepts is applied; and

FIG. 8 is a diagram illustrating a personal computer to which a touch sensing device of inventive concepts is applied.

### DETAILED DESCRIPTION

Embodiments will be described in detail with reference to the accompanying drawings. Inventive concepts, however, may be embodied in various different forms, and should not be construed as being limited only to the illustrated embodiments. Rather, these embodiments are provided as examples so that this disclosure will be thorough and complete, and will fully convey the concept of inventive concepts to those skilled in the art. Accordingly, known processes, elements, and techniques are not described with respect to some of the embodiments of inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element (s) or feature (s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

In the following description, example embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like, which may be referred to as processors.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

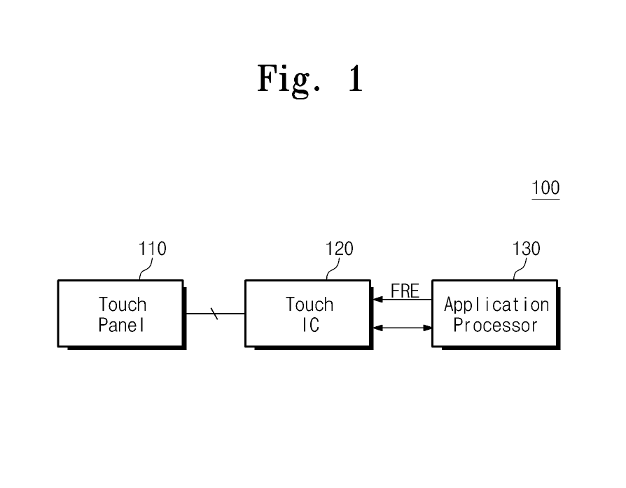

FIG. 1 is a block diagram schematically illustrating a touch sensing device 100 according to an embodiment of inventive concepts. Referring to FIG. 1, a touch sensing device 100 may include a touch panel 110, a touch integrated circuit 120, and an application processor 130.

The touch sensing device 100 may control a scan frequency based on a busy application. The touch sensing device 100 may control a scan frequency according to a touch sensing speed required for the busy application. When an application not requiring high-speed touch sensing is running, the touch sensing device 100 may scan the touch panel 110 with a low scan frequency to reduce power consumption.

The touch panel 110 may include a plurality of sensing nodes, each of which includes a sensor for sensing a touch of a user. The touch panel 110 may convert a sensing result into an electrical signal, and may provide the electrical signal to the touch integrated circuit 120. In example embodiments, a touch sensing method of the touch panel 110 may not be limited thereto.

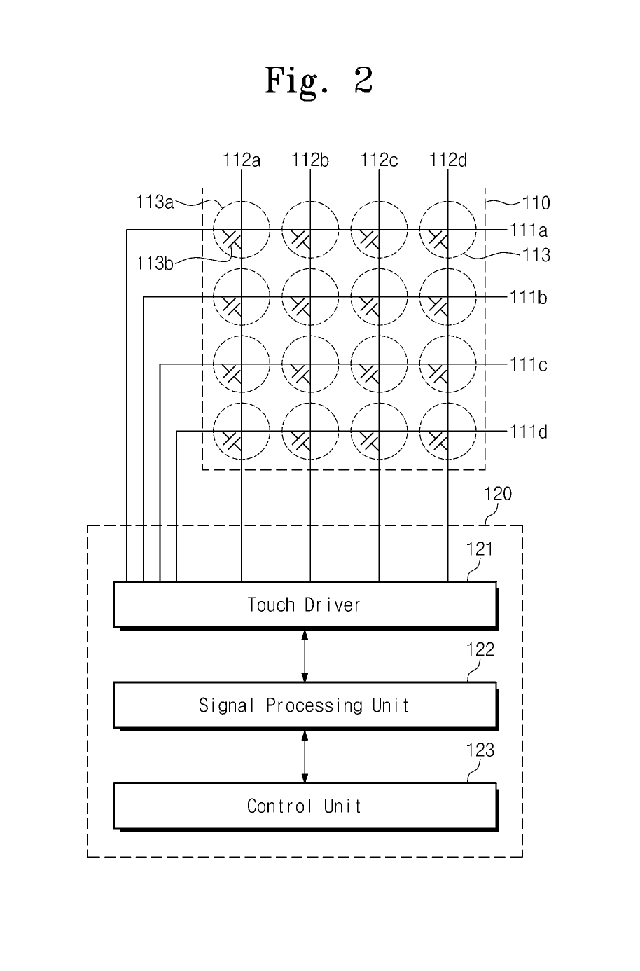

For example, the touch panel 110 may sense a capacitance value of a sensing node. If a user touches a panel, a capacitance value of a peripheral sensing node of a touch point may vary by mutual capacitance between the user and the panel. The touch panel 110 may provide the touch integrated circuit 120 with the electrical signal indicating a capacitance value. This will be more fully described with reference to FIG. 2.

The touch panel 110 may include a user interface or a display unit for providing a display. For example, the touch panel 110 may include as a display means a liquid crystal display (LCD) device, an organic light emitting display (OLED) device, a field emission display (FED) device, or a plasma display device (PDP).

The touch integrated circuit 120 may control an operation of the touch panel 110. The touch integrated circuit 120 may sense a touch operation of a user from an electrical signal transferred from the touch panel 110. The touch integrated circuit 120 may scan the touch panel 110 with a scan frequency to sense a touch operation.

As a scan frequency for scanning the touch panel 110 increases, the touch integrated circuit 120 may rapidly recognize a touch operation of a user. On the other hand, as a scan frequency for scanning the touch panel 110 decreases, an operation of recognizing the touch operation of the user may be delayed. However, as a scan frequency for scanning the touch panel 110 increases, power consumption of the touch sensing device 100 may increase.

The touch integrated circuit 120 may be connected with the application processor 130. The touch integrated circuit 120 may recognize a type of application running at the touch sensing device 100 through the application processor 130.

An application running at the touch sensing device 100 may require different touch recognition speeds according to characteristics. For example, in the case that an application for drawing a picture on a panel through a touch operation is executed, the touch operation may be recognized rapidly without a delay. On the other hand, in the event that an application for playing a moving picture is running, a predetermined delay time may be allowed at recognition of a touch operation.

The touch integrated circuit 120 may adjust a scan frequency in response to a control of the application processor 130. The touch sensing device 100 may provide recognition speed and power consumption on a busy application by adjusting of a scan frequency through the touch integrated circuit 120.

The application processor 130 may control an operation of the touch sensing device 100. The application processor 130 may drive an operating system (OS) and an application running at the touch sensing device 100. The application processor 130 may include a central processing unit (CPU), a graphics processing unit (GPU), and so on.

The application processor 130 may provide the touch integrated circuit 120 with a scan frequency adjusting signal FRE based on a type of an application currently running. In example embodiments, an application currently running may mean an application, occupying a use of a touch panel, from among applications currently stored at a memory. The touch integrated circuit 120 may adjust a scan frequency of the touch panel 110 in response to the scan frequency adjusting signal FRE.

The touch sensing device 100 may adjust a scan frequency based on a type of application running. The touch sensing device 100 may determine the recognition speed and power consumption on a busy application by adjusting the scan frequency.

FIG. 2 is a detailed block diagram illustrating a touch panel 110 and a touch integrated circuit 120 of FIG. 1. Referring to FIG. 2, the touch integrated circuit 120 may include a touch driver 121, a signal processing unit 122, and a control unit 123.

The touch panel 110 may include a plurality of TX driving lines 111a to 111d, a plurality of RX sensing lines 112a to 112d, and a sensing node array 113 of sensing nodes disposed at intersections of the lines. In FIG. 2, there are illustrated four TX driving lines and four RX sensing lines. Since the sensing nodes of the sensing node array 113 have the same structure, a detailed description of one sensing node 113a will be made.

The sensing node 113a may have mutual capacitance 113b varied by a driving current flowing through the TX driving line 111a and an external factor. The external factor causing a variation in the mutual capacitance 113b of the sensing node 113a may include a touch of a user.

The mutual capacitance 113b of the sensing node 113a generated by the driving current flowing through the TX driving line 111a may be transferred as an electrical signal through the RX sensing line 112a. The electrical signal may be a current or a voltage. A level of the electrical signal may vary according to the mutual capacitance 113b of the sensing node 113a.

The touch driver 121 may provide driving currents to the TX driving lines 111a to 111d. The touch driver 121 may sense mutual capacitance values of the sensing node array 113 through the RX sensing lines 112a to 112d.

The touch driver 121 may change a scan frequency of a driving current applied to each of the TX driving lines 111a to 111d. The touch driver 121 may change the scan frequency in response to the scan frequency control signal FRE from the application processor 130 (refer to FIG. 1). As the scan frequency of the driving current varies, a touch recognizing speed and power consumption of a touch sensing device 100 (refer to FIG. 1) may vary.

The signal processing unit 122 may process electrical signals received from the RX sensing lines 112a to 112d through the touch driver 121 to generate touch data. The signal processing unit 122 may include an ADC (Analog-to-Digital Converter). An electrical signal which the signal processing unit 122 receives from the touch driver 121 may be an analog signal. The signal processing unit 122 may convert an analog signal into a digital signal using the ADC to output touch data as a conversion result.

The control unit 123 may decide a touch state of the touch panel 110 based on the touch data provided from the signal processing unit 122. The control unit 123 may compare the touch data with a reference value to decide a touch state of each sensing node. The control unit 123 may send the decided touch states to the application processor 130.

The touch integrated circuit 120 may change the scan frequency of a driving current provided to each of the TX driving lines 111a to 111d of the touch pane 110 in response to the scan frequency control signal FRE. The scan frequency control signal FRE may be generated based on a type of application running. Thus, the touch integrated circuit 120 may change a scan frequency in response to a type of application, so that power consumption of the touch sensing device 100 is adjusted.

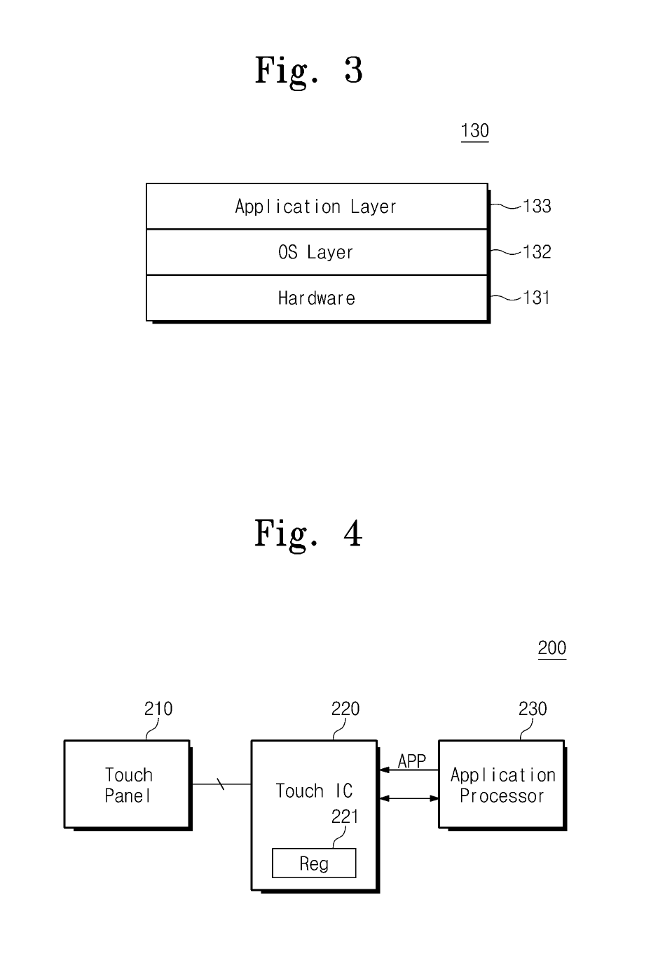

FIG. 3 is a block diagram schematically illustrating layers of the application processor 130 of FIG. 1. Referring to FIG. 3, the application processor 130 may include hardware 131, an operating system layer 132, and an application layer 133.

The operating system layer 132 may provide an interface for controlling the hardware 131. The operating system layer 132 may include a hardware abstraction layer (HAL) for controlling the hardware 131. In example embodiments, the operating system layer 132 may not be limited thereto.

The application layer 133 may be an application program (i.e., an application) for executing a specific function of the touch sensing device 100. The application layer 133 may use an API (Application Programming Interface) library for communication with the operating system layer 132.

The application layer 133 may include a scan frequency control program. The scan frequency control program may recognize a type of application running at the application layer 133. The scan frequency control program may enable the application processor 130 to control a scan frequency of the touch integrated circuit 120, based on the recognized application type.

The application processor 130 may control a scan frequency using the scan frequency control program running at the application layer 133. However, inventive concepts are not limited thereto.

FIG. 4 is a block diagram schematically illustrating a touch sensing device 200 according to another example embodiment of inventive concepts. Referring to FIG. 4, a touch sensing device 200 may include a touch panel 210, a touch integrated circuit 220, and an application processor 230. The touch panel 210 of FIG. 4 may be configured substantially the same as a touch panel 110 of FIG. 1.

The touch integrated circuit 220 may be connected with the application processor 230. The touch integrated circuit 220 may be provided with information APP (hereinafter, referred to as application information) on a currently running application from the application processor 230. The touch integrated circuit 220 may adjust a scan frequency on the touch panel 210 in response to the application information APP.

The touch integrated circuit 220 may include a register 221. The register 221 may store a plurality of scan frequencies different from one another. The touch integrated circuit 220 may selectively load a scan frequency from the register 221 in response to the application information APP. The touch integrated circuit 220 may drive the touch panel 210 with the loaded scan frequency.

The application information APP may include information associated with a type of application currently running. The register 221 may store a scan frequency corresponding to a specific application. If the specific application is recognized from the application information APP, the touch integrated circuit 220 may load and use a scan frequency corresponding to the application from the register 221.

Also, the application information APP may include a result of classifying a busy application based on a predetermined reference. For example, applications may be divided into a plurality of groups according to touch recognition speeds. The application information APP may direct a group to which the busy application belongs.

The register 221 may store scan frequencies corresponding to the groups. If a specific group is recognized from the application information APP, the touch integrated circuit 220 may load and use a scan frequency corresponding to the group from the register 221.

Also, the register 221 may store a default scan frequency as an initial setting value. At booting of the touch sensing device 200 and during execution of an unclassified application, the touch integrated circuit 220 may drive the touch panel 210 with the default scan frequency.

The touch integrated circuit 220 may selectively load a scan frequency from the register 221 in response to the application information APP to drive the touch panel 210 with the loaded scan frequency. Thus, the touch integrated circuit 220 may change a scan frequency in response to a type of application, so that power consumption of the touch sensing device 200 is adjusted.

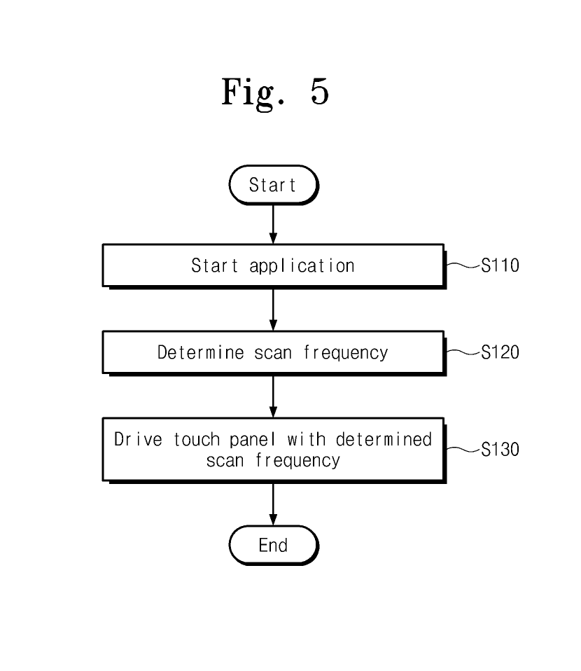

FIG. 5 is a flow chart illustrating a driving method of a touch sensing device according to an example embodiment of inventive concepts.

In operation S110, an application may be executed by an application processor. The application processor may recognize a type of application running/executed.

In operation S120, a touch panel IC decides a scan frequency for driving a touch panel according to the recognized application type. The scan frequency may be decided according to a touch sensing speed which the recognized application requires. The higher a touch sensing speed required by an application, the higher the scan frequency. A level of the scan frequency may be selected from among a plurality of levels.

In operation S130, a touch panel may be driven with the decided scan frequency by the touch panel IC. Since the scan frequency is decided based on an application currently running, the touch sensing speed and power consumption of a touch sensing device may be adjusted according to a type of application.

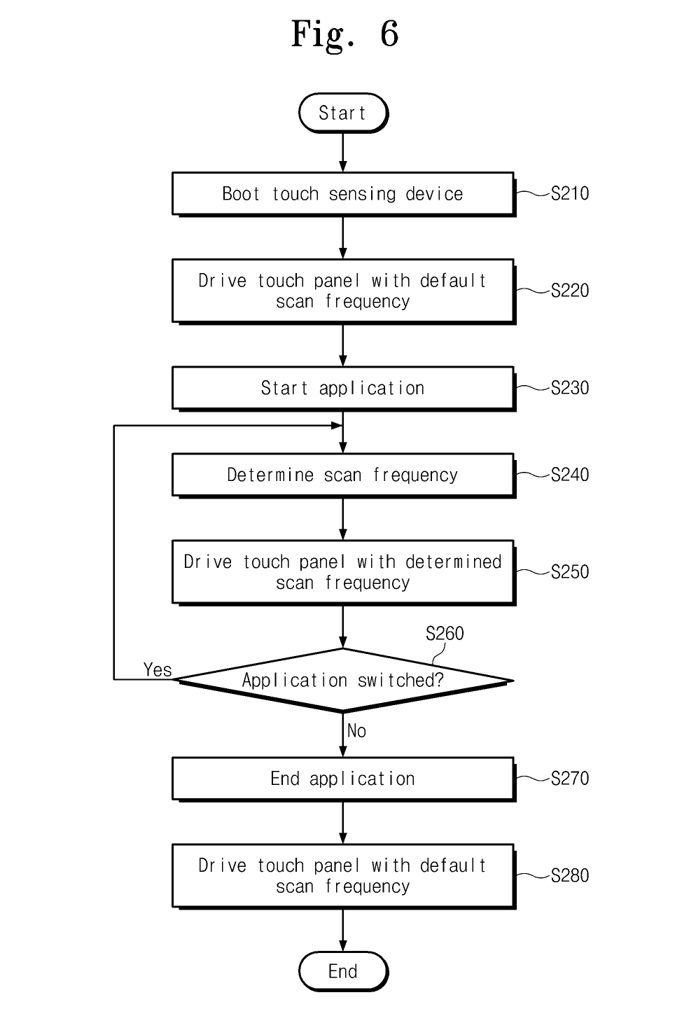

If an application running at the touch sensing device is changed, a scan frequency may be also changed. This will be more fully described with reference to FIG. 6.

FIG. 6 is a flow chart illustrating a method of controlling an operation of a touch sensing device according to an example embodiment of inventive concepts.

In operation S210, a touch sensing device may be booted. The touch sensing device may be booted by an operating system stored at an application processor.

In operation S220, a touch panel may be driven by a touch panel IC with a default scan frequency. The default scan frequency may be predetermined by the touch panel IC. However, the default scan frequency may not be limited to a specific value.

In operation S230, an application may be executed by the application processor. The application may be provided with a touch state through a touch integrated circuit. The touch integrated circuit may drive a touch panel to provide the touch state.

In operation S240, the touch panel IC may determine a scan frequency by which the touch panel is driven. The scan frequency based on a touch sensing speed which the executed application requires. The higher a touch sensing speed of the application, the higher the scan frequency. The touch panel IC may select a level of the scan frequency from among a plurality of levels.

In operation S250, the touch panel may be driven with the decided scan frequency by the touch panel IC. Since the scan frequency is decided based on an application currently running, the touch sensing speed and power consumption of a touch sensing device may be adjusted according to a type of application.

In operation S260, whether an application is switched may be determined by the touch panel IC. Herein, switching of the application may mean that an application enters a sleep mode without deleting of the application from a memory and a new application is executed. If switching of the application is made, in operation S240, a scan frequency corresponding to the new application may be decided.

In operation S270, an application previously executed may be ended. If the application previously executed is ended, the touch panel may be driven with the default scan frequency in operation S280.

With the operating method of the touch sensing device, if an application running is switched or ended, a scan frequency may be again adjusted. Thus, the touch sensing speed and power consumption of a touch sensing device may be adjusted according to switching of the application.

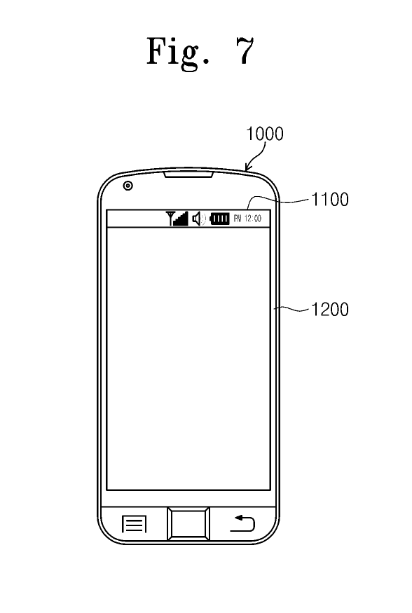

FIG. 7 is a diagram illustrating a handheld phone to which a touch sensing device of inventive concepts is applied. Referring to FIG. 7, a handheld phone 1000 may include a touch panel 1100 and a touch integrated circuit 1200.

The touch panel 1100 may provide a user interface according to a control of an application processor. The touch panel 1100 may include a plurality of sensing nodes. The touch panel 1100 may sense a touch of a user to provide an electrical signal indicating a mutual capacitance variation of the sensing node to the touch integrated circuit 1200.

The touch integrated circuit 1200 may decide a touch state of the sensing node based on the input electrical signal. The touch integrated circuit 1200 may calculate a coordinate of a sensing node touched to provide it to the application processor.

Also, the touch integrated circuit 1200 may receive information of an application running from the application processor, and may control a scan frequency of the touch panel 1100 in response to the received information. The touch integrated circuit 1200 may be configured substantially the same as a touch integrated circuit 120 (refer to FIG. 1).

The handheld phone 1000 including the touch sensing device of inventive concepts may adjust the touch sensing speed and power consumption according to an application running.

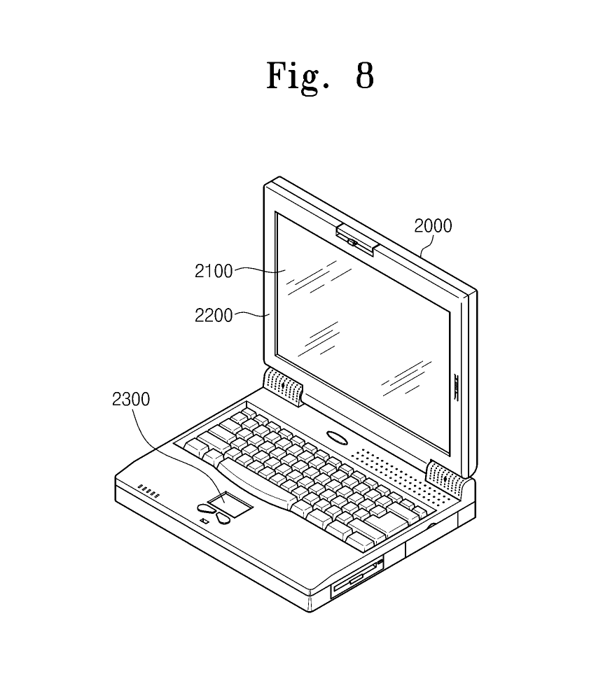

FIG. 8 is a diagram illustrating a personal computer to which a touch sensing device of inventive concepts is applied. Referring to FIG. 8, a personal computer 2000 may include a first touch panel unit 2100, a touch integrated circuit 2200, and a second touch panel unit 2300.

The first touch panel unit 2100 may provide a user interface according to a control of an application processor. The first touch panel unit 2100 may include a plurality of sensing nodes. The first touch panel unit 2100 may sense a touch of a user to provide an electrical signal indicating a mutual capacitance variation of the sensing node to the touch integrated circuit 2200.

The second touch panel unit 2300 may include a plurality of sensing nodes. The second touch panel unit 2300 may sense a touch of a user to provide an electrical signal indicating a mutual capacitance variation of the sensing node to the touch integrated circuit 2200.

The touch integrated circuit 2200 may decide a touch state of a sensing node in at least one of the first and second touch panel unit 2100 and 2300 based on an electrical signal received from at least one of the first and second touch panel unit 2100 and 2300. The touch integrated circuit 2200 may calculate a coordinate of a sensing node touched to provide it to the application processor.

Also, the touch integrated circuit 2200 may receive information of an application running from the application processor, and may control a scan frequency of the touch panel 2100 in response to the received information. The touch integrated circuit 2200 may be configured substantially the same as a touch integrated circuit 120 (refer to FIG. 1).

The personal computer 2000 including the touch sensing device of inventive concepts may adjust the touch sensing speed and power consumption according to an application running.

Inventive concepts may be modified or changed variously. For example, a touch panel, a touch integrated circuit, and an application processor may be changed or modified variously according to environment and use. While inventive concepts have been described with reference to exemplary embodiments, it will be apparent to those skilled in the art that various changes and modifications may be made without departing from the spirit and scope of the present invention. Therefore, it should be understood that the above embodiments are not limiting, but illustrative.

1. A touch sensing device comprising:
a touch panel;
a touch integrated circuit configured to scan the touch panel at a scan frequency; and
an application processor configured to provide application information on an application activated at the touch sensing device,
wherein the touch integrated circuit is configured to adjust the scan frequency in response to the application information.

2. The touch sensing device of claim 1, wherein the touch panel comprises:
a plurality of TX driving lines;
a plurality of RX sensing lines; and
a sensing node array including sensing nodes formed at intersections of the TX driving lines and the RX sensing lines,
wherein the touch integrated circuit is configured to provide a driving current having the scan frequency to the TX driving lines.

3. The touch sensing device of claim 1, wherein the application information identifies a group of a plurality of groups to which the activated application belongs,
the touch integrated circuit has a register storing a plurality of scan frequencies corresponding to the plurality of groups, and
the touch integrated circuit loads one of the plurality of scan frequencies in response to the application information to drive the touch panel with the loaded scan frequency.

4. A touch integrated circuit configured to scan a touch panel at a scan frequency, the touch integrated circuit configured to adjust the scan frequency in response to application information provided from an application processor, the application information being information associated with an activated application.

5. The touch integrated circuit of claim 4, wherein the application information is a scan frequency control signal indicating a touch recognition speed of the activated application.

6. The touch integrated circuit of claim 4, wherein the touch integrated circuit comprises:
a touch driver configured to provide the touch panel with a driving current having the scan frequency;
a signal processing unit configured to convert an electrical signal provided from the touch panel into a digital signal; and
a control unit configured to determine a touch state of the touch panel based on the digital signal.

7. The touch integrated circuit of claim 4, wherein the application information identifies a group of a plurality of groups to which the activated application belongs.

8. The touch integrated circuit of claim 7, further comprising:
a register configured to store a plurality of scan frequencies corresponding to the plurality of groups, and
wherein the touch integrated circuit is configured to load one of the plurality of scan frequencies in response to the application information to drive the touch panel with the loaded scan frequency.

9. The touch integrated circuit of claim 8, wherein the register is configured to store a default scan frequency and the touch integrated circuit is configured to drive the touch panel with the default scan frequency at booting.

10.-15. (canceled)

16. A touch panel integrated circuit configured to adjust a scan frequency of the touch panel based on an application.

17. The touch panel integrated circuit of claim 16, wherein the touch panel integrated circuit includes,
a register configured to store a plurality of candidate scan frequencies and the touch panel integrated circuit is configured to select one of the plurality of candidate scan frequencies as the adjusted scan frequency.

18. The touch panel integrated circuit of claim 17, where the touch panel integrated circuit is configured to select one of the plurality of candidate scan frequencies based on a type of the application.

19. The touch panel integrated circuit of claim 16, wherein the touch panel integrated circuit is configured to adjust the scan frequency based on a type of the application.
